(19) United States
(12) Patent Application Publication
(10) Pub. No.: US 2020/0317913 A1
(43) Pub. Date: Oct. 8, 2020

(54) THERMOSETTING RESIN COMPOSITION

(71) Applicant: TEIJIN LIMITED, Osaka-shi, Osaka (JP)

(72) Inventors: Shinichiro SHOJI, Osaki-shi, Osaka (JP); Tomoyoshi YAMAMOTO, Osaki-shi, Osaka (JP)

(73) Assignee: TEIJIN LIMITED, Osaka-shi, Osaka (JP)

(21) Appl. No.: 16/955,148

(22) PCT Filed: Dec. 21, 2018
(86) PCT No.: PCT/JP2018/047382

§ 371 Date: Jun. 18, 2020

(30) Foreign Application Priority Data
Dec. 22, 2017 (JP) 2017-246968

(51) Int. Cl. C08L 79/00; C08J 5/24; C08K 5/3442

(52) U.S. Cl. CPC C08L 79/00; C08J 2379/00; C08K 5/3442; C08J 5/24

(57) ABSTRACT

An object of the present invention is to provide a cyanate ester-based curable resin composition having a high curing rate, very high heat resistance and very high long-term heat resistance, and a molded article and a prepreg each using the same. The present invention relates to a thermosetting resin composition including (A) a cyanate ester compound and/or (B) an unsaturated imide compound, and (C) a cyclic carbodiimide compound. In addition, the present invention relates to a molded article including a cured product of the thermosetting resin composition, and a prepreg including a reinforcing fiber substrate impregnated with the thermosetting resin composition.

### FIELD

The present invention relates to a thermosetting resin composition.

### BACKGROUND

A cyanate ester compound is a compound having a cyanate group (—OCN). This compound is known to undergo polymerization while producing a triazine ring structure by cyclization and trimerization, and the resulting cured resin has very high heat resistance attributable to the triazine ring structure. Accordingly, a cured resin of the cyanate ester compound is used in the fields requiring high functionality, for example, in electronic material applications such as printed wiring board material, or in aerospace applications.

Patent Literatures (PTLs) 1 and 2 disclose such a cyanate ester-based composition.

In addition, an unsaturated imide compound is also known to give the same cured resin.

A typical unsaturated imide compound is a bismaleimide compound, and it is known that an unsaturated bond of a maleimide group is polymerized to provide a cured resin having very high heat resistance. An unsaturated imide compound may also be used as a co-curing reactive compound and co-cured with a cyanate ester compound.

PTL 3 discloses a technique of capping the terminal carboxyl group of a polyester with a cyclic carbodiimide compound so as to suppress the hydrolysis of the polyester. In addition, PTL 4 discloses an epoxy resin composition containing a cyclic carbodiimide compound as a curing agent and discloses that such an epoxy resin composition has high heat resistance.

### CITATION LIST

### Patent Literature

[PTL 1] Japanese Unexamined Patent Publication No. 2015-89899

[PTL 2] Japanese Unexamined Patent Publication No. 2006-124494

[PTL 3] International Publication WO 2010/071213

[PTL 4] International Publication WO 2016/039486

### SUMMARY

### Technical Problem

An object of the present invention is to provide a cyanate ester-based curable resin composition having a high curing rate, very high heat resistance and very high long-term heat resistance, and a prepreg using the same.

### Solution to Problem

The present inventors have found that the above-described object can be attained by the present invention having the following aspects.

### <<Aspect 1>>

A thermosetting resin composition including:

(A) a cyanate ester compound and/or (B) an unsaturated imide compound, and

(C) a cyclic carbodiimide compound.

### <<Aspect 2>>

The thermosetting resin composition according to Aspect 1, including the (A) cyanate ester compound.

### <<Aspect 3>>

The thermosetting resin composition according to Aspect 2, wherein the (A) cyanate ester compound has at least two cyanate groups per molecule.

### <<Aspect 4>>

The thermosetting resin composition according to Aspect 2 or 3, wherein the (A) cyanate ester compound is a compound represented by the following formula (1):

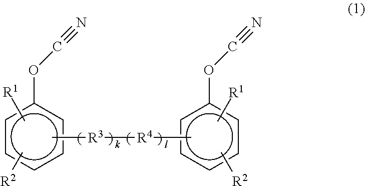

wherein R¹ and R² are the same or different and each represents hydrogen atom, an alkyl group or alkyl halide group having from 1 to 20 carbon atoms, or a halogen group;

R³ are the same or different and each represents an organic group represented by the following chemical formula:

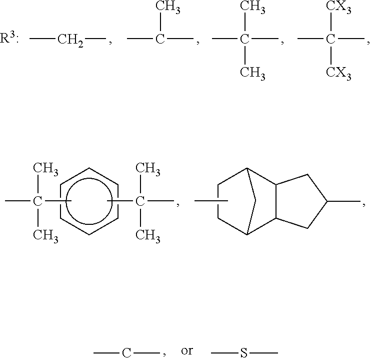

wherein R⁴ are the same or different and each represents an organic group represented by the following chemical formula:

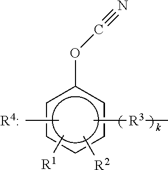

wherein k is 0 or 1; and 1 represents an integer of 0 to 10.

### <<Aspect 5>>

The thermosetting resin composition according to Aspect 1, including the (B) unsaturated imide compound.

### <<Aspect 6>>

The thermosetting resin composition according to Aspect 5, wherein the (B) unsaturated imide compound is a bismaleimide compound.

### <<Aspect 7>>

The thermosetting resin composition according to any one of Aspects 1 to 6, wherein the (C) cyclic carbodiimide compound is a compound containing at least one cyclic structure represented by the following formula (2):

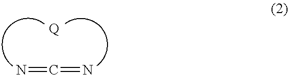

wherein Q is a divalent to tetravalent linking group which is an aliphatic group, an alicyclic group, an aromatic group, or a combination thereof and may contain a heteroatom and/or a substituent.

### <<Aspect 8>>

The thermosetting resin composition according to any one of Aspects 1 to 7, wherein the (C) cyclic carbodiimide compound is a compound represented by the following formula (2-1):

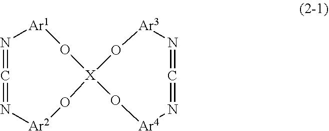

wherein X is a tetravalent group represented by the following formula (i):

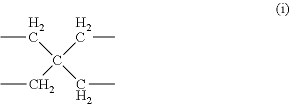

wherein each of Ar¹ to Ar⁴ is independently a divalent monocyclic or fused polycyclic alicyclic group, aromatic group or heterocyclic group, which may have a substituent, wherein the substituent is selected from the group consisting of an alkyl group having from 1 to 20 carbon atoms, an aryl group having from 6 to 15 carbon atoms, a halogen atom, a nitro group, an amide group, a hydroxyl group, an ester group, an ether group and an aldehyde group and when each of Ar¹ to Ar⁴ is a heterocyclic group, the heterocyclic group contains a heteroatom selected from the group consisting of O, N, S and P.

### <<Aspect 9>>

The thermosetting resin composition according to any one of Aspects 1 to 8, including:

the (A) cyanate ester compound,

the (B) unsaturated imide compound, and

the (C) cyclic carbodiimide compound.

### <<Aspect 10>>

The thermosetting resin composition according to Aspect 9, wherein the (C) cyclic carbodiimide compound is contained in a range of 1 to 30 parts by mass per 100 parts by mass of the total of the (A) cyanate ester compound and the (B) unsaturated imide compound.

### <<Aspect 11>>

The thermosetting resin composition according to Aspect 9 or 10, wherein the (A) cyanate ester compound and the (B) unsaturated imide compound are contained at a mass ratio of 90:10 to 50:50.

### <<Aspect 12>>

A molded article including a cured product of the thermosetting resin composition according to any one of Aspects 1 to 11.

### <<Aspect 13>>

A prepreg including a reinforcing fiber substrate impregnated with the thermosetting resin composition according to any one of Aspects 1 to 11.

### <<Aspect 14>>

A fiber-reinforced composite material obtained by curing the prepreg according to Aspect 13.

### DESCRIPTION OF EMBODIMENTS

The thermosetting resin composition of the present invention comprises (A) a cyanate ester compound and/or (B) an unsaturated imide compound, and (C) a cyclic carbodiimide compound.

As described above, it is thought that (A) a cyanate ester group produces a triazine ring structure by cyclization and trimerization of a cyanate group (—OCN) and a cyanate ester-based resin thereby exhibits very high heat resistance. In addition, (B) an unsaturated imide compound is also known to give a cured resin having very high heat resistance due to polymerization of an unsaturated bond of a maleimide group.

The present inventors have found that when the cyanate ester-based resin and/or (B) unsaturated imide compound having very high heat resistance contains a small amount of a cyclic carbodiimide compound in its monomer, a polymer having a higher glass transition temperature is obtained. Furthermore, although a conventional resin deteriorates in heat resistance when processed at a high temperature for a long time, a cured resin obtained from the resin composition of the present invention is not substantially deteriorated in heat resistance even when processed at a high temperature for a long time. It is extremely difficult for conventional techniques to obtain such a cyanate ester-based cured resin or imide-based cured resin having very high heat resistance and very high long-term heat resistance, and the resin can be expected to further expand its application range in the fields requiring high functionality, such as electronic material applications and aerospace applications.

It has also been found that the thermosetting resin composition of the present invention has a high curing rate, compared with a composition not containing a cyclic carbodiimide compound. Unexpectedly, the composition of the present invention starts the curing reaction early, compared with a composition not containing a cyclic carbodiimide compound, nevertheless, its cured product has very high heat resistance and very high long-term heat resistance.

Without being bound by theory, it is believed that since the thermosetting resin composition of the present invention contains a cyclic carbodiimide compound, a reaction occurs between a cyanate group and/or an unsaturated imide group and a carbodiimide group, in addition to the multimerization reaction of the cyanate ester compound and/or the polymerization reaction of the unsaturated imide compound. It is believed that due to occurrence of a reaction between such a functional group and a carbodiimide group, a heterocyclic ring having a high nitrogen content is formed and this allows for exhibiting very high heat resistance. It is also believed that even when a thermal decomposition of the cyanate ester compound and/or unsaturated imide compound occurs, the terminal cleaved by the thermal decomposition reacts to restore a carbodiimide group and the isocyanate group produced in association therewith serves as a further curing component and makes it possible to exhibit long-term heat resistance.

### <(A) Cyanate Ester Compound>

The thermosetting resin composition of the present invention can contain (A) a cyanate ester compound. The (A) cyanate ester compound is not particularly limited as long as it has a cyanate group (—OCN), but a compound having at least two cyanate groups per molecule is preferred, and a compound having at least two cyanate groups and at least one aromatic ring or fused aromatic ring per molecule is more preferred. For example, the (A) cyanate ester compound can be a compound having two to four, or two to three, cyanate groups and one to three, or up to two, aromatic rings or fused rings which each may have a substituent. In the present description, the (A) cyanate ester compound encompasses a cyanate ester compound and a prepolymer thereof.

Specific examples of the (A) cyanate ester compound include 1,3- or 1,4-dicyanatobenzene, 1,3,5-tricyanatobenzene, 1,3-, 1,4-, 1,6-, 1,8-, 2,6- or 2,7-dicyanatonaphthalene, 1,3,6-tricyanatonaphthalene, 4,4-dicyanatobiphenyl, bis(4-cyanatophenyl)methane, bis(3,5-dimethyl-4-cyanatophenyl)methane, 2,2-bis(4-cyanatophenyl)propane, 2,2-bis(3,5-dibromo-4-cyanatophenyl)propane, 2,2-bis(3,5-dimethyl-4-cyanatophenyl)propane, bis(4-cyanatophenyl)ether, bis(4-cyanatophenyl)thioether, bis(4-cyanatophenyl)sulfone, tris(4-cyanatophenyl)phosphite, tris(4-cyanatophenyl)phosphate, a cyanate ester compound obtained by a reaction of an oligomer of novolac or hydroxyl group-containing thermoplastic resin (e.g., hydroxypolyphenylene ether, hydroxypolystyrene, hydroxypolycarbonate) with a cyanogen halide, and a cyanate ester compound obtained by reacting a polyfunctional phenol in which the phenol is bonded to dicyclopentadiene, with a cyanogen halide, and one of these or an appropriate mixture of two or more thereof can be used.

As the (A) cyanate ester compound, 1,3- or 1,4-dicyanatobenzene, 1,3,5-tricyanatobenzene, bis(3,5-dimethyl-4-cyanatophenyl)methane, bis(4-cyanatophenyl)methane, 2,2-bis(4-cyanatophenyl)propane, and phenol novolac cyanate are preferred, and 2,2-bis(4-cyanatophenyl)propane is more preferred. Prepolymers having a molecular weight of 400 to 6,000 and having a triazine ring formed by trimerization of a cyanate group of these cyanate ester compounds are favorably used.

For example, the (A) cyanate ester compound includes a compound represented by the following formula (1):

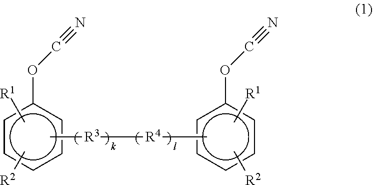

wherein R¹ and R² are the same or different and each represents hydrogen atom, an alkyl group or alkyl halide group having from 1 to 20 carbon atoms, or a halogen group;

R³ are the same or different and each represents an organic group represented by the following chemical formula:

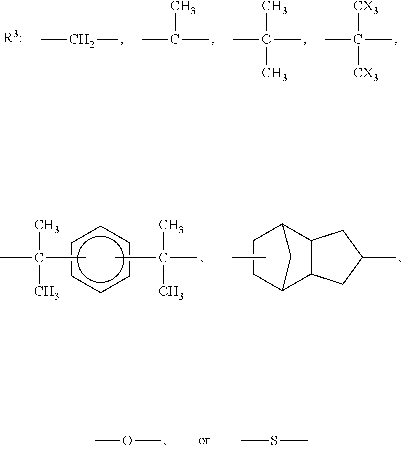

wherein R⁴ are the same or different and each represents an organic group represented by the following chemical formula:

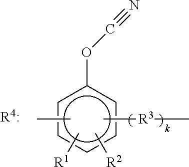

wherein k is 0 or 1; and 1 represents an integer of 0 to 10.

The compound represented by formula (1) includes, although there is some overlap with specific examples of the above-described cyanate ester compound, for example, bis(4-cyanatophenyl)methane, bis(3,5-dimethyl-4-cyanatophenyl)methane, a divalent phenol cyanate ester such as bis(3-methyl-4-cyanatophenyl)methane, bis(4-cyanatophenyl)-1,1-ethane, bis(4-cyanatophenyl)-2,2-ethane, 2,2-bis(4-cyanatophenyl)propane, 2,2-bis(3,5-dimethyl-4-cyanatophenyl)methane, di(4-cyanatophenyl)ether, di(4-cyanatophenyl)thioether, 4,4-{1,3-phenylenebis(1-methylethylidene)}bisphenyl cyanate, 4,4-dicyanatophenyl, 2,2-bis(4-cyanatophenyl)-1,1,1,3,3,3-hexafluoropropane, 1,1′-bis-(p-cyanatophenyl)-ethane, 2,2′-bis(p-cyanatophenyl)propane, 4,4′-methylenebis(2,6-dimethylphenyl cyanate), 2,2′-bis(p-cyanatophenyl)hexafluoropropane and α,α′-bis(4-cyanatophenyl)-m-diisopropylbenzene: a trivalent phenol cyanate ester such as tris(4-cyanatophenyl)-1,1,1-ethane and bis(3,5-dimethyl-4-cyanatophenyl)-4-cyanatophenyl-1,1,1-ethane; a phenol novolac-type cyanate ester, a cresol novolac-type cyanate ester, a dicyclopentadiene bisphenol-type cyanate ester: etc. Among these, in view of dielectric property, curability, etc. of the cured product, 2,2-bis(4-cyanatophenyl)propane and a phenol novolac-type cyanate ester are preferred.

As the (A) cyanate ester compound, a prepolymer (e.g., trimer, pentamer) obtained by forming a triazine ring structure by cyclization of a cyanate group possessed by the compound represented by formula (1) may also be used. Among others, in view of operability or solubility in other curable resins, a trimer is preferred.

The prepolymer may be obtained by subjecting a monomer of the cyanate ester compound above to polymerization using, as a catalyst, for example, acids such as mineral acid and Lewis acid; a base such as sodium alcoholate, etc. and tertiary amines; and salts such as sodium carbonate.

### <(B) Unsaturated Imide Compound>

The thermosetting resin composition of the present invention can contain (B) an unsaturated imide compound. The (B) unsaturated imide compound is a compound having an unsaturated imide group, which not only undergoes a curing reaction by itself but also can cure the composition by reacting with the cyanate ester compound. In the present description, the (B) unsaturated imide compound encompasses an unsaturated imide compound and a prepolymer thereof. In addition, the unsaturated imide group as used herein means an imide group having a polymerizable unsaturated bond.

The compound having an unsaturated imide group is not particularly limited but is preferably a compound having a maleimide group or a nadimide group.

The compound having a maleimide group is not particularly limited but includes a bismaleimide compound (bismaleimide resin). The bismaleimide compound is not particularly limited as long as it is a compound having two or more maleimide groups in the molecule. The compound includes, for example, co-condensed products of bismaleimide and an aldehyde compound, and one of these or two or more thereof may be used. Furthermore, the compound having a maleimide compound includes an aromatic maleimide in which maleimide is bonded to an aromatic ring, and in particular, includes an aromatic bismaleimide in which a maleimide group is bonded to each of two aromatic rings.

The bismaleimide compound includes, for example, 4,4′-diphenylmethanebismaleimide, N,N′-ethylenebismaleimide, N,N′-hexamethylenebismaleimide, N,N′-m-phenylenebismaleimide, N,N′-p-phenylenebismaleimide, 2,2-bis[4-(4-maleimidophenoxy)phenyl]propane, bis[4-(4-maleimidophenoxy)phenyl]methane, 1,1,1,3,3,3-hexafluoro-2,2-bis[4-(4-maleimidophenoxy)phenyl]propane, N,N′-p,p′-diphenyldimethylsilylbismaleimide, N,N′-4,4′-diphenyletherbismaleimide, N,N′-methylenebis(3-chloro-p-phenylene)bismaleimide, N,N′-4,4′-diphenylsulfonebismaleimide, N,N′-4,4′-dicyclohexylmethanebismaleimide, N,N′-dimethylenecyclohexanebismaleimide, N,N′-m-xylenebismaleimide, N,N′-4,4′-diphenylcyclohexanebismaleimide, N-phenylmaleimide, polyphenylmethanemaleimide, etc. Among others, the aldehyde compound above includes, for example, formaldehyde, acetaldehyde, benzaldehyde, hydroxyphenylaldehyde, etc.

The compound having a nadimide group is not particularly limited but is preferably an imidation reaction product of an aromatic amine compound and a norbornene dicarboxylic anhydride. The nadimide compound is not particularly limited as long as it is a compound having two or more nadimide groups within the molecule, and one of these compounds or two or more thereof may be used.

The nadimide compound includes, for example, 4,4′-diphenylmethanebisnadimide, N,N′-ethylenebisnadimide, N,N′-hexamethylenebisnadimide, N,N′-m-phenylenebisnadimide, N,N′-p-phenylenebisnadimide, 2,2-bis[4-(4-nadimidophenoxy)phenyl]propane, bis[4-(4-nadimidophenoxy)phenyl]methane, 1,1,1,3,3,3-hexafluoro-2,2-bis[4-(4-nadimidophenoxy)phenyl]propane. N,N′-p,p′-diphenyldimethylsilylbisnadimide, N,N′-4,4′-diphenyletherbisnadimide, N,N′-methylenebis(3-chloro-p-phenylene)bis-nadimide, N,N′-4,4′-diphenylsulfonebisnadimide, N,N′-4,4′-dicyclohexylmethanebisnadimide, N,N′-dimethylenecyclohexanebisnadimide, N,N′-m-xylenebisnadimide, N,N′-4,4′-diphenylcyclohexanebisnadimide, N-phenylnadimide, etc. Among others, the aldehyde compound above includes, for example, formaldehyde, acetaldehyde, benzaldehyde, hydroxyphenylaldehyde, etc.

The (B) unsaturated imide compound can be incorporated into the thermosetting resin composition in an amount of 10 parts by mass or more, 20 parts by mass or more, 50 parts by mass or more, 100 parts by mass or more, 150 parts by mass or more, or 20 parts by mass or more, and can be incorporated into the thermosetting resin composition in an amount of 500 parts by mass or less, 400 parts by mass or less, 300 parts by mass or less, 200 parts by mass or less, 150 parts by mass or less, 100 parts by mass or less, 50 parts by mass or less, or 30 parts by mass or less, per 100 parts by mass of the (A) cyanate ester compound. For example, in the thermosetting resin composition, the (A) cyanate ester compound and the (B) unsaturated imide compound may be contained at a mass ratio of 90:10 to 50:50 or 80:20 to 60:40.

### <(C) Cyclic Carbodiimide Compound>

As the (C) cyclic carbodiimide compound, cyclic carbodiimide compounds described in PTLs 3 and 4 can be used.

For example, the (C) cyclic carbodiimide compound may be a compound containing at least one cyclic structure consisting of 8 or more or 10 or more atoms and 50 or less, 30 or less, 20 or less, or 15 or less atoms, which is a compound containing a divalent carbodiimide group (—N═C═N—) in a part of the cyclic structure. In this case, the compound may contain two or more cyclic structures, and the cyclic structure may be a spiro ring structure. The carbodiimide group may be contained in each of the cyclic structures, or only one carbodiimide group may be contained in one cyclic moiety. It is preferable for the (C) cyclic carbodiimide compound to contain only one carbodiimide group in one cyclic structure.

The number of atoms in the cyclic structure means the number of atoms directly constituting the cyclic structure and is, for example, 8 in the case of a 8-membered ring or 50 in the case of a 50-membered ring. When the number of atoms in the cyclic structure is from 8 to 50, the stability of the cyclic carbodiimide compound can be maintained to a certain degree, and this makes storage and use relatively easy. The number of ring members is not particularly limited in its upper limit value, but in view of reactivity, synthesis of (C) a cyclic carbodiimide compound having a number of atoms of 50 or less is relatively facilitated. From this point of view, the number of atoms in the cyclic structure is preferably from 10 to 30, more preferably from 10 to 20, still more preferably from 10 to 15.

From the viewpoint of enhancing the heat resistance of the curable resin, the (C) cyclic carbodiimide compound is preferably a polyvalent cyclic carbodiimide compound containing two or more carbodiimide groups per molecule. Above all, in the case of using the compound as a curing agent of the thermosetting resin composition, in view of curing performance, the compound preferably contains two or three carbodiimide groups per molecule. Two or more of these cyclic carbodiimide compounds can be used in combination.

The molecular weight of the (C) cyclic carbodiimide compound is preferably from 100 to 1,000. Within this range, a problem with the structural stability and volatility of the (C) cyclic carbodiimide compound is less likely to arise, and the yield when synthesizing the (C) cyclic carbodiimide compound is relatively improved. From this point of view, the molecular weight is more preferably from 100 to 750, still more preferably from 250 to 750.

For example, the (C) cyclic carbodiimide compound may be a compound having a cyclic structure represented by the following formula (2):

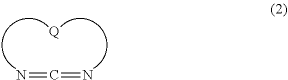

wherein Q is a divalent to tetravalent linking group which is an aliphatic group, an alicyclic group, an aromatic group, or a combination thereof and may contain a heteroatom and/or a substituent.

In the formula, Q is preferably a group represented by —Ar^{a}—O—X—O—Ar^{b}—. Each of Ar^{a} and Ar^{b} is independently a monocyclic or fused polycyclic alicyclic group, aromatic group or heterocyclic group, which may have a substituent, and is preferably a phenylene group or a naphthalene-diyl group, which may have a substituent. In this case, the substituent includes an alkyl group having from 1 to 20 carbon atoms, an aryl group having from 6 to 15 carbon atoms, a halogen atom, a nitro group, an amide group, a hydroxyl group, an ester group, an ether group, an aldehyde group, etc. and is preferably an alkyl group having from 1 to 6 carbon atoms or a phenyl group. X is preferably an alkanediyl group in the case of having two cyclic structures and is preferably an alkanetetrayl group in the case of having four cyclic structures.

The (C) cyclic carbodiimide compound includes, for example, a compound represented by formula (2-1):

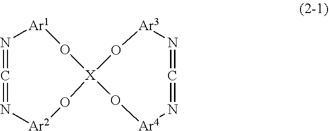

In the formula, X is a tetravalent group represented by the following formula (i). Each of Ar¹ to Ar⁴ is independently a divalent monocyclic or fused polycyclic alicyclic group, aromatic group or heterocyclic group, which may have a substituent, and is preferably an orthophenylene group or a 1,2-naphthalene-diyl group, which may have a substituent. The substituent includes an alkyl group having from 1 to 20 carbon atoms, an aryl group having from 6 to 15 carbon atoms, a halogen atom, a nitro group, an amide group, a hydroxyl group, an ester group, an ether group, an aldehyde group, etc. In the case where each of Ar¹ to Ar⁴ is a heterocyclic group, the heterocyclic group contains a heteroatom selected from the group consisting of O, N. S and P.

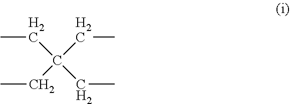

Examples of the (C) cyclic carbodiimide compound which can be favorably used include a compound represented by the following formula (2-2) or (2-3):

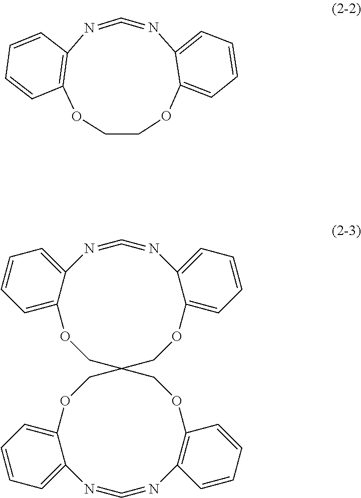 [SMILES: C1=Nc2ccccc2OCCOc2ccccc2N=1 ; C1=Nc2ccccc2OCC2(COc3ccccc3N=1)COc1ccccc1N=C=Nc1ccccc1OC2]

The (C) cyclic carbodiimide compound can be incorporated into the thermosetting resin composition in an amount of 1 part by mass or more, 3 parts by mass or more, 5 parts by mass or more, 10 parts by mass or more, 12 parts by mass or more, or 15 parts by mass or more, and can be incorporated into the thermosetting resin composition in an amount of 30 parts by mass or less. 20 parts by mass or less. 15 parts by mass or less, or 10 parts by mass or less, per 100 parts by mass of the (A) cyanate ester compound and/or the (B) unsaturated imide compound.

### <Others>

In the thermosetting resin composition of the present invention, other thermosetting resins or thermoplastic resins, such as epoxy resin and phenol resin, may be used in combination, if desired. Such resins include the resins disclosed as a resin that can be used in combination in the resin described in PTL 2. On the other hand, in the present invention, a composition not containing these other resins is also preferred so as to obtain very high heat resistance. For example, in the thermosetting resin composition, the content of other resin components may be 50 parts by mass or less, 30 parts by mass or less, 20 parts by mass or less, 10 parts by mass or less, 5 parts by mass or less, 3 parts by mass or less, 1 part by mass or less, or 0.1 parts by mass or less, per 100 parts by mass of the total of the (A) cyanate ester compound, the (B) unsaturated imide compound and the (C) cyclic carbodiimide compound.

The thermosetting resin composition of the present invention is cured by heating, but for the purpose of further promoting the curing, a known curing catalyst or curing accelerator may be additionally blended.

In the thermosetting resin composition of the present invention, as long as the original properties of the composition are not impaired, various additives can be blended according to the purpose of its end use. These additives are natural or synthetic resins, an inorganic or organic fibrous reinforcement, a filler, etc. and are used in appropriate combination as needed. In addition, various additives such as dye, pigment, thickener, lubricant, dispersant, leveling agent, photosensitizer, flame retardant, brightening agent, polymerization inhibitor and thixotropy-imparting agent are used in appropriate combination as needed.

### <<Curing Method of Thermosetting Resin>>

The curing conditions of the above-described thermosetting resin composition vary depending on, for example, the component ratio of the resin composition or the presence or absence of the additional curing catalyst or curing accelerator, but the composition can be heat-treated for a predetermined time by appropriately selecting the temperature in the range of usually from 100 to 300° C. to obtain a heat-cured product. On this occasion, the pressure setting is not particularly limited, but in general, it is preferable to apply a pressure, and the pressure may be appropriately selected in the range of usually from 0.01 to 50 MPa, preferably from 0.5 to 15 MPa.

### <<Molded Article>>

The molded article of the present invention can be obtained by curing the above-described thermosetting resin composition and may have various forms such as plate shape, sheet shape and three-dimensional shape. In the case of obtaining the molded article, a known molding method such as transfer molding, sheet molding, compression molding and press molding may be used. In addition, the thermosetting resin composition in a liquid state may be applied on a sheet substrate by means of a bar coater, a die coater, a doctor blade, a baker applicator, etc. and cured to form a laminate of the cured product and the sheet substrate, or the cured product may be separated from the sheet substrate to take on a sheet shape.

Incidentally, the usage of the molded article includes a prepreg, a metal foil-clad laminate, a resin sheet, an insulating layer of a printed wiring board, a semiconductor package material, etc.

### <<Prepreg>>

The prepreg of the present invention is prepared by impregnating a reinforcing fiber substrate with the above-described thermosetting resin composition. The prepreg of the present invention has very high heat resistance and very high long-term heat resistance and therefore, is extremely useful in the fields requiring high functionality, such as electronic material applications and aerospace applications. The prepreg of the present invention can adopt the same configuration and production method as those for the conventional prepreg formed from a thermosetting resin composition using a cyanate ester compound, etc.

The reinforcing fiber constituting the reinforcing fiber substrate includes carbon fiber, glass fiber, aramid fiber, silicon carbide fiber, polyester fiber, ceramic fiber, alumina fiber, boron fiber, metal fiber, mineral fiber, rock fiber, slag fiber, etc. Of these reinforcing fibers, carbon fiber, glass fiber, and aramid fiber are preferred: carbon fiber that gives a lightweight high-strength fiber-reinforced composite material with improved specific strength and specific modulus is more preferred; and among carbon fibers, a polyacrylonitrile (PAN)-based carbon fiber having excellent tensile strength is still more preferred.

The shape of the reinforcing fiber substrate is not limited, but a sheet-shaped material is preferred in view of processability. The reinforcing fiber sheet includes, for example, a sheet-shaped material obtained by unidirectionally aligning a number of reinforcing fibers, a bidirectional fabric such as plain weave or twill weave, a multi-axial fabric, a nonwoven fabric, a mat, a knit, a braid, and a paper obtained by subjecting reinforcing fibers to papermaking. The thickness of the reinforcing fiber sheet is preferably from 0.01 to 3 mm, more preferably from 0.1 to 1.5 mm. In addition, the basis weight of the reinforcing fiber sheet is preferably from 70 to 400 g/m², more preferably from 100 to 300 g/m².

The content of the thermosetting resin composition in the prepreg is preferably from 20 to 60 parts by mass, more preferably from 30 to 50 parts by mass, relative to the total mass of the reinforcing fiber substrate and the thermosetting resin composition. Within this range, the possibility of generating a void, etc. inside the fiber-reinforced composite material is low, and the content of the reinforcing fiber becomes sufficiently high, so that the strength of the prepreg obtained can be increased.

The prepreg can be produced by impregnating the inside of the reinforcing fiber substrate with the thermosetting resin composition. As the method for impregnating the inside of the reinforcing fiber substrate with the thermosetting resin composition, a known wet process or dry process can be used. Among these, it is preferable to use a hot-melt method that is a dry process.

In the hot-melt method, a stack of the thermosetting resin composition and a reinforcing fiber substrate is heated under pressure, thereby reducing the viscosity of the thermosetting resin composition and impregnating the inside of the reinforcing fiber substrate with the thermosetting resin composition. In the case where the reinforcing fiber substrate is a sheet-shaped material, the resin composition formed into a film shape is preferably stacked on the reinforcing fiber substrate.

### <<Fiber-Reinforced Composite Material>>

The fiber-reinforced composite material of the present invention is obtained by curing the above-described prepreg by a known method. The method for producing the fiber-reinforced composite material by using the prepreg of the present invention includes conventionally known methods, for example, a method of using manual lay-up, automated tape lay-up (ATL), automated fiber placement, vacuum bagging, autoclave cure, out of autoclave cure, fluid assisted processing, pressure assisted processes, matched mold processes, simple press cure, press-clave cure, or continuous band pressing.

The fiber-reinforced composite material may be a copper-clad laminate obtained by laminating a copper foil on the prepreg and curing the stack or may be a printed wiring board manufactured from the copper-clad laminate.

The present invention is described more specifically below by referring to Examples, but the present invention is not limited thereto.

### EXAMPLES

### Experiment 1: Experiment with Respect to a Composition Containing (A) a Cyanate Ester Compound, (B) an Unsaturated Imide Compound, and (C) a Cyclic Carbodiimide Compound

### Example 1 and Comparative Examples 1 and 2

### Production Example

Bisphenol A dicyanate (hereinafter, referred to as “BADCY”) that is a representative compound as the (A) cyanate ester compound; 4,4′-phenylmethanebismaleimide (hereinafter, referred to as “BMI”) that is a representative compound as the (B) unsaturated imide compound; and as the (C) cyclic carbodiimide compound, a compound (hereinafter, referred to as “SX-1”) represented by the following formula (2-3), were prepared. In addition, a cobalt naphthenate mineral spirit solution (6 w/v %, hereinafter referred to as “Co naphthenate”) was prepared as the curing catalyst used in the reaction of the (A) cyanate ester compound with the (B) unsaturated imide compound.

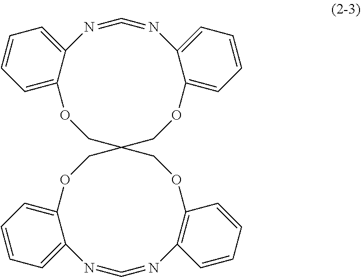 [SMILES: C1=Nc2ccccc2OCC2(COc3ccccc3N=1)COc1ccccc1N=C=Nc1ccccc1OC2]

3.5 g of the (A) cyanate ester compound above was charged into a 30-m scale screw tubular vial and after raising the temperature by use of a constant-temperature drier “ON-300S” (manufactured by AS ONE Corporation) until the inner temperature reaches 150° C., the contents were taken out and thoroughly stirred with a stirring bar. This operation was repeated to melt the (A) cyanate ester compound. Furthermore, 1.5 g of the (B) unsaturated imide compound was added and dissolved by the same operation. Finally, the (C) cyclic carbodiimide compound or the curing catalyst was added in the amount shown in Table 1, and these were quickly mixed to produce a uniform resin composition. In addition, a composition containing the (A) cyanate ester compound and the (B) unsaturated imide compound, in which the (C) cyclic carbodiimide compound and curing catalyst are not added, was also prepared. In this way, the thermosetting resin compositions of Example 1 and Comparative Examples 1 and 2 were produced.

### <Evaluation>

On a Teflon-coated stainless steel plate, 1 g of the resin composition was set and cured at 150° C. for 0.5 hours, at 170° C. for 2 hours and finally at 240° C. by using a constant-temperature drier “ON-300S” (manufactured by AS ONE Corporation).

During curing at 240° C., sampling was performed after the elapse of 0.5 hours, 1 hour, 2 hours, and 4 hours, and Tg measurement was conducted at each sampling.

In the Tg measurement, the glass transition temperature (Tg) was measured using DSC (TA-2920, manufactured by TA Instruments) by raising the temperature of the produced thermosetting resin composition, in a first cycle, up to 320° C. at 20° C./min under a nitrogen flow.

### <Results>

The results are shown together in Table 1.

TABLE 1

| | (A) | (B) | (C) | Co | Change in Tg Over Time When Heated at 240° C. | | | |
|---|---|---|---|---|---|---|---|---|
| | BADCY | BMI | SX-1 | Naphthenate | after 0.5 h | after 1.0 h | after 2.0 h | after 4.0 h |
| Example 1 | 70 | 30 | 10 | — | 239 | 245 | 257 | 256 |
| Comparative | 70 | 30 | — | — | uncured | 232 | 245 | 229 |
| Example 1 | | | | | | | | |
| Comparative | 70 | 30 | — | 0.1 | 207 | 225 | 240 | 232 |
| Example 2 | | | | | | | | |

In Comparative Example 1 where neither a cyclic carbodiimide compound nor a curing catalyst is contained, the time necessary for curing was long and moreover, Tg was greatly reduced after 4 hours of heating. In Comparative Example 2 where a curing agent is contained, the time necessary for curing was relatively short, but the maximum Tg was low, and Tg was reduced after 4 hours of heating. On the other hand, the thermoplastic resin composition of the present invention containing a cyclic carbodiimide compound maintained high Tg even after 4 hours of heating while having very high Tg after 0.5 hours of heating at 240° C.

### Example 2 and Comparative Example 3

### Production Example

The same experiment as the experiment above was performed using bis(3-ethyl-5-methyl-4-maleimidophenyl)methane as the (B) unsaturated imide compound.

More specifically, 1.3 g of the (A) cyanate ester compound (BADCY) was charged into a 13.5-ml scale glass cup ((GC-24) manufactured by AS ONE Corporation) and after raising the temperature by use of a constant-temperature drier “ON-300S” (manufactured by AS ONE Corporation) until the inner temperature reaches 160° C., the contents were taken out and thoroughly stirred with a stirring bar. This operation was repeated to melt the cyanate ester compound. Furthermore, 0.13 g of the (C) cyclic carbodiimide compound (SX-1) was added and dissolved by the same operation. Finally, 0.69 g of the (B) unsaturated imide compound above was added and dissolved by the same operation to produce a uniform resin composition of Example 2. In addition, a composition of Comparative Example 3 containing only the (A) cyanate ester compound and the (B) unsaturated imide compound, in which the (C) cyclic carbodiimide compound is not added, was also prepared.

### <Evaluation and Results>

On a Teflon-coated stainless steel plate, 1 g of the resin composition was set and cured at 150° C. for 0.5 hours, at 170° C. for 2 hours, and finally at 240° C. by using a constant-temperature drier “ON-300S” (manufactured by AS ONE Corporation), as a result, similarly to the experiment above, curing acceleration was confirmed in the resin composition of Example 2 containing a cyclic carbodiimide compound.

### Experiment 2: Experiment with Respect to a Composition Containing (A) a Cyanate Ester Compound and (C) a Cyclic Carbodiimide Compound

### Example 3 and Comparative Example 4

### Production Example

0.5 g of the (A) cyanate ester compound (BADCY) was charged into a 13.5-ml scale glass cup ((GC-24) manufactured by AS ONE Corporation) and after raising the temperature by use of a constant-temperature drier “ON-300S” (manufactured by AS ONE Corporation) until the inner temperature reaches 160° C., the contents were taken out and thoroughly stirred with a stirring bar. This operation was repeated to melt the (A) cyanate ester compound. Furthermore, 0.1 g of the (C) cyclic carbodiimide compound (SX-1) was added and dissolved by the same operation to produce a resin composition of Example 3. In addition, a composition of Comparative Example 4 containing only the (A) cyanate ester compound (BADCY), in which the (C) cyclic carbodiimide compound is not added, was also prepared.

### <Evaluation and Results>

On a Teflon-coated stainless steel plate, 1 g of the resin composition was set and cured at 150° C. for 0.5 hours and at 170° C. for 2 hours by using a constant-temperature drier “ON-300S” (manufactured by AS ONE Corporation), as a result, curing acceleration was confirmed in the resin composition of Example 3 containing a cyclic carbodiimide compound.

### Experiment 3: Experiment with Respect to a Composition Containing (B) an Unsaturated Imide Compound and (C) a Cyclic Carbodiimide Compound

### Example 4 and Comparative Example 5

### Production Example

0.5 g of the (B) unsaturated imide compound (BMI) was charged into a 13.5-ml scale glass cup ((GC-24) manufactured by AS ONE Corporation) and after raising the temperature by use of a constant-temperature drier “ON-300S” (manufactured by AS ONE Corporation) until the inner temperature reaches 160° C., the contents were taken out and thoroughly stirred with a stirring bar. This operation was repeated to melt the (B) unsaturated imide compound. Furthermore, 0.1 g of the (C) cyclic carbodiimide compound (SX-1) was added and dissolved by the same operation. In addition, a composition of Comparative Example 5 containing only the (B) unsaturated imide compound (BMI), in which the (C) cyclic carbodiimide compound is not added, was also prepared.

### <Evaluation and Results>

On a Teflon-coated stainless steel plate, 0.4 g of the resin composition was set and cured at 150° C. for 0.5 hours and at 170° C. for 2 hours by using a constant-temperature drier “ON-300S” (manufactured by AS ONE Corporation), as a result, curing acceleration was confirmed in the resin composition of Example 4 containing a cyclic carbodiimide compound.

### Experiment 4: Test of Molded Article

### Example 5 and Comparative Example 6

### Production of Resin Sheet

50.96 g of the (A) cyanate ester compound (BADCY) was charged into a 100-ml scale heat-resistant beaker and after raising the temperature by use of a constant-temperature drier “ON-300S” (manufactured by AS ONE Corporation) until the inner temperature reaches 210° C., the contents were taken out and thoroughly stirred with a stirring bar. This operation was repeated to melt the (A) cyanate ester compound. Subsequently, 5.096 g of the (C) cyclic carbodiimide compound (SX-1) was added and dissolved by the same operation.

Furthermore, 21.84 g of the (B) unsaturated imide compound (BMI) was added and dissolved by the same operation. The resulting mixed solution was cast in the prepared mold and defoamed for 10 minutes in full vacuum at an inner temperature of 165° C. by using a vacuum drier “AVO-250N” (manufactured by AS ONE Corporation). As for the mold, a curing mold for resin sheet, having an outside diameter of 14 cm×10 cm square, an inside diameter of 12 cm×8 cm square and a height of 1.2 cm, was produced by cutting silicon rubber sheets (produced by AS ONE Corporation) having a thickness of 1 cm and a thickness of 2 mm and used by sticking an adhesive VALFLON tape onto its bottom.

After the defoaming, the mold having cast thereinto the mixed solution was quickly charged into a constant-temperature drier “ON-300S” (manufactured by AS ONE Corporation) in which the temperature had been raised until the inner temperature reaches 170° C., and curing was performed at 170° C. for 2 hours. Subsequently, the mold was once taken out and after raising the temperature until the inner temperature of the constant-temperature drier reaches 240° C., again charged, and curing was performed for 4 hours.

The obtained resin sheet was cut out with a diamond saw (manufactured by LUXO), and a specimen suited to the size in each physical property evaluation was prepared using sandpaper (manufactured by ESCO, Ltd.) #240, #1000 and #2000. In addition, with respect to a specimen for bend test, mirror finishing with an alumina suspension (Bukowski Japan) was additionally performed.

Furthermore, a composition containing only the (A) cyanate ester compound and the (B) unsaturated imide compound but not containing the (C) cyclic carbodiimide compound was also prepared. However, the melting temperature at the time of melt-mixing respective components was changed from 210 to 180° C.

In this way, resin specimens of the thermosetting resin compositions of Example 5 and Comparative Example 6 were produced.

### <Evaluation>

Using the prepared specimen (44 mm×12 mm×2 mm), DMA measurement was performed under the following conditions, and E″ and tan δ were determined from the chart.

Measuring apparatus: “RSA-3” manufactured by TA Instruments

Measurement atmosphere: nitrogen

Temperature rise rate: 5 K/min

Temperature range: from 100 to 320° C. (Comparative Example 3), from 100 to 350° C. (Example 2)

Vibration frequency: 10 Hz

Strain: 0.1% (set value)

Geometry: three-point bending (between lower beams: 40 mm)

Sample width: 12 mm, sample thickness: 2 mm

Static load/dynamic load ratio=1.1

Using the prepared specimen (80 mm×10 mm×4 mm), measurement by Tensilon was performed under the following conditions, and the modulus and elongation at break were determined from the measured values.

Measuring apparatus: “RTC-1225A” manufactured by ORIENTEC Corporation

Load cell: “UR-1kN-D” manufactured by ORIENTEC Corporation

Measurement standard: JIS K7171

Test speed: 2 mm/min

Geometry: three-point bending

Inter-fulcrum distance L: L=16×h (64 mm)

Sample length: 80 mm (three-point average)

Width: 10 mm (three-point average)

Thickness: 4 mm=h (three-point average)

Test temperature: 25° C.

Using the prepared specimen (5 mm×5 mm×5 mm), TMA measurement was performed under the following conditions, and the linear expansion coefficient and dimensional change rate were determined from the measured values.

Measuring apparatus: “TMA Q400” manufactured by TA Instruments

Measurement mode: compression (macroexpansion probe, diameter: 6.07 mm)

Load: 0.05 N

Measurement temperature range: from 20 to 310° C.

Temperature rise rate: 5° C./min

Measurement atmosphere: He gas (50 ml/min)

Analysis conditions:

The value was determined by performing the analysis at 30 to 200° C. (low-temperature region) and 200 to 300° C. (high-temperature region) for the linear expansion coefficient and at 30 to 300° C. for the dimensional change rate.

### <Results>

The results are shown together in Table 2.

TABLE 2

| | | | | TMA | | | | |
|---|---|---|---|---|---|---|---|---|
| | | | | Linear Expansion | | | | |
| | | | | Coefficient | | | | |
| | | | | [μm/m · ° C.] | | | Tensilon | |
| | | DMA | | Low- | High- | Dimensional | | Elongation |
| | (C) | E″ | tan δ | Temperature | Temperature | Change Rate | Modulus | at Break |
| | SX-1 | [° C.] | [° C.] | Region | Region | [%] | [GPa] | [%] |
| Example 5 | added | 255 | 287 | 50.7 | 101.7 | 1.88 | 3,79 | 5.15 |
| Comparative | none | 219 | 270 | 55,8 | 123.3 | 2.18 | 3.73 | 5.14 |
| Example 6 | | | | | | | | |

It is seen that the molded article of Example 5 cured using the (C) cyclic carbodiimide compound has high heat resistance and dimensional stability while having mechanical properties equal to or higher than those of the molded article of Comparative Example 6.

### INDUSTRIAL APPLICABILITY

The thermosetting resin composition of the present invention is utilized in various applications by making use of its excellent physical properties and workability and is favorably used, for example, as a prepreg, a printed wiring board material such as copper-clad laminate, a structural material, a casting resin, etc.

1. A thermosetting resin composition comprising:
(A) a cyanate ester compound and/or (B) an unsaturated imide compound, and
(C) a cyclic carbodiimide compound.

2. The thermosetting resin composition according to claim 1, comprising the (A) cyanate ester compound.

3. The thermosetting resin composition according to claim 2, wherein the (A) cyanate ester compound has at least two cyanate groups per molecule.

4. The thermosetting resin composition according to claim 2, wherein the (A) cyanate ester compound is a compound represented by the following formula (1): 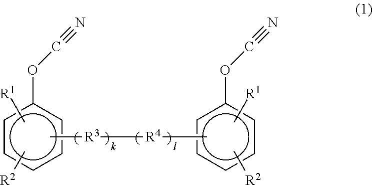
wherein R and R² are the same or different and each represents hydrogen atom, an alkyl group or alkyl halide group having from 1 to 20 carbon atoms, or a halogen group;
R³ are the same or different and each represents an organic group represented by the following chemical formula: 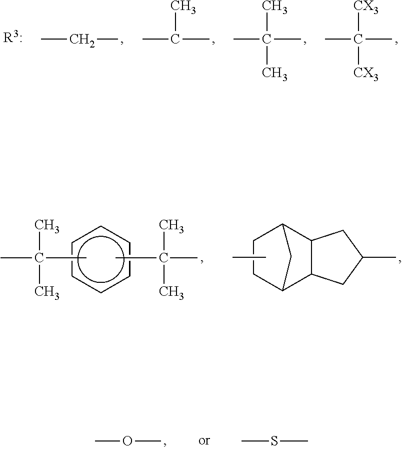
wherein R⁴ are the same or different and each represents an organic group represented by the following chemical formula: 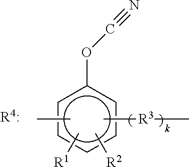
wherein k is 0 or 1; and 1 represents an integer of 0 to 10.

5. The thermosetting resin composition according to claim 1, comprising the (B) unsaturated imide compound.

6. The thermosetting resin composition according to claim 5, wherein the (B) unsaturated imide compound is a bismaleimide compound.

7. The thermosetting resin composition according to claim 1, wherein the (C) cyclic carbodiimide compound is a compound containing at least one cyclic structure represented by the following formula (2): 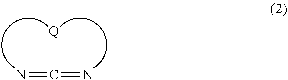
wherein Q is a divalent to tetravalent linking group which is an aliphatic group, an alicyclic group, an aromatic group, or a combination thereof and may contain a heteroatom and/or a substituent.

8. The thermosetting resin composition according to claim 1, wherein the (C) cyclic carbodiimide compound is a compound represented by the following formula (2-1): 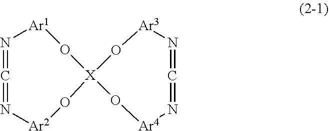
wherein X is a tetravalent group represented by the following formula (i): 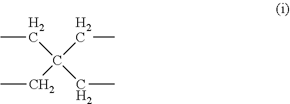
wherein each of Ar¹ to Ar⁴ is independently a divalent monocyclic or fused polycyclic alicyclic group, aromatic group or heterocyclic group, which may have a substituent, wherein the substituent is selected from the group consisting of an alkyl group having from 1 to 20 carbon atoms, an aryl group having from 6 to 15 carbon atoms, a halogen atom, a nitro group, an amide group, a hydroxyl group, an ester group, an ether group and an aldehyde group and when each of Ar¹ to Ar⁴ is a heterocyclic group, the heterocyclic group contains a heteroatom selected from the group consisting of O, N, S and P.

9. The thermosetting resin composition according to claim 1, comprising:
the (A) cyanate ester compound,
the (B) unsaturated imide compound, and
the (C) cyclic carbodiimide compound.

10. The thermosetting resin composition according to claim 9, wherein the (C) cyclic carbodiimide compound is contained in a range of 1 to 30 parts by mass per 100 parts by mass of the total of the (A) cyanate ester compound and the (B) unsaturated imide compound.

11. The thermosetting resin composition according to claim 9, wherein the (A) cyanate ester compound and the (B) unsaturated imide compound are contained at a mass ratio of 90:10 to 50:50.

12. A molded article comprising a cured product of the thermosetting resin composition according to claim 1.

13. A prepreg comprising a reinforcing fiber substrate impregnated with the thermosetting resin composition according to claim 1.

14. A fiber-reinforced composite material obtained by curing the prepreg according to claim 13.
